(19) United States
(12) Patent Application Publication
(10) Pub. No.: US 2006/0104537 A1
(43) Pub. Date: May 18, 2006

(54) System and method for image enhancement

(75) Inventor: Albert D. Edgar, Austin, TX (US)

Correspondence Address: ANDERSON & JANSSON, L.L.P., 9501 N. CAPITAL OF TX HWY. #202, AUSTIN, TX, 78759, US

(73) Assignee: SozoTek, Inc., Austin, TX (US)

(21) Appl. No.: 11/271,707

(22) Filed: Nov. 10, 2005

Related U.S. Application Data
(63) Continuation-in-part of application No. 11/203,564, filed on Aug. 12, 2005.
(60) Provisional application No. 60/627,135, filed on Nov. 12, 2004.

(51) Int. Cl. G06K 9/40

(52) U.S. Cl. 382/275; 382/254

(57) ABSTRACT

Provided is a system and method for processing images. A method is provided for separating the image into two or more spatial phase data components, determining a luminance value multiplier to enable the two or more spatial phase data components to match in luminance, using the luminance value multiplier to determine one or more residue components for one or more of the two or more spatial phase data components, the residue components representing one or more concentrated noise components of the image, and performing noise reduction of the one or more residue components.

### CROSS-REFERENCE TO RELATED APPLICATION

This is a continuation-in-part of the patent application of Albert D. Edgar entitled “SYSTEM AND METHOD FOR REDUCTION OF CHROMA ALIASING AND NOISE IN A COLOR-MATRIXED SENSOR” application Ser. No. 11/203,564, filed Aug. 12, 2005, the entire contents of which are fully incorporated by reference herein for all purposes.

This is a continuation-in-part of provisional patent application of Albert D. Edgar entitled, “SYSTEM AND METHOD FOR CROSS CORRELATION” application Ser. No. 60/627,135, filed Nov. 12, 2004, the entire contents of which are fully incorporated by reference herein for all purposes.

### TECHNICAL FIELD

The present application relates generally to the field of image processing.

### BACKGROUND

Digital cameras are more and more popular as the technology supporting them improves. One area of image processing in need of improvement is the noise removal. Noise management is critical for digital imaging. Known methods of removing noise from digital images include applying a filter to remove high frequencies, blurring an image and the like.

Another technology area that is in need of improvement is the effect of aliasing. Depending on the type and expense of a digital camera, the aliasing can be more or less present. Aliasing typically manifests as Moiré patterns on images with high frequency repetitive patterns, such as window screens and fabrics. More expensive cameras reduce aliasing by anti-aliasing (low pass) filters, which are expensive and unavoidably reduce resolution by introducing “blurring” of signal. Other methods for reducing aliasing include providing a digital camera with pixels smaller than 4 μm, which causes other problems such as lens diffraction, which prevents small aperture images and generally any aperture lower than f/5.6.

Currently, digital cameras typically employ a color filter array, which includes a filter grid covering a sensor array so that each pixel is sensitive to a single primary color, either red (R), green (G), or blue (B). Typically, a Bayer pattern includes a pattern with two green pixels for each red and blue pixel. Green typically covers 50% of a Bayer array because the human eye is most sensitive green.

A Bayer array is known to suffer from artifact, resolution and aliasing issues. Many of the issues with a Bayer array are due to Moiré fringing caused by the interpolation process used to determine data for the two missing colors at each pixel location. The red and blue pixels are spaced twice as far apart as the green pixels. Thus, the resolution for the red and blue pixels is roughly half that of green. Many reconstruction algorithms have been developed to interpolate image data, but interpolation can result in file size growth and can require a time consuming algorithm. Given the computationally intensity of better interpolation algorithms, they are typically performed on a computer and not in a camera. What is needed is a solution for aliasing, noise and artifact removal for digital cameras.

### SUMMARY

Provided is a system and method for processing images. A computer system, computer program product and method is provided for image enhancement. The method provides for separating the image into two or more spatial phase data components, determining a luminance value multiplier to enable the two or more spatial phase data components to match in luminance, using the luminance value multiplier to determine one or more residue components for one or more of the two or more spatial phase data components, the residue components representing one or more concentrated noise components of the image, and performing noise reduction of the one or more residue components.

The foregoing is a summary and thus contains, by necessity, simplifications, generalizations and omissions of detail; consequently, those skilled in the art will appreciate that the summary is illustrative only and is NOT intended to be in any way limiting. Other aspects, features, and advantages of the devices and/or processes and/or other subject described herein will become apparent in the text set forth herein.

### BRIEF DESCRIPTION OF THE DRAWINGS

A better understanding of the subject matter of the present application can be obtained when the following detailed description of the disclosed embodiments is considered in conjunction with the following drawings, in which:

FIG. 1 is a block diagram of an exemplary computer architecture that supports the claimed subject matter.

FIG. 2 is a block diagram illustrating a Bayer sensor array appropriate for embodiments of the present application.

FIG. 3 is a schematic block diagram illustrating signal flow methods in accordance with an embodiment of the present application.

FIG. 4 is a schematic block diagram illustrating post processing methods in accordance with an embodiment of the present application.

FIG. 5 is a flow diagram illustrating a method in accordance with an embodiment of the present application.

FIG. 6 is a block diagram illustrating a computer system in accordance with an embodiment of the present application.

FIGS. 7-18 are images illustrating embodiments of the present application. The file of this patent contains at least one drawing executed in color. Copies of this patent with color drawings will be provided by the Patent and Trademark Office upon request and payment of the necessary fee.

### DETAILED DESCRIPTION OF THE DRAWINGS

Those with skill in the computing arts will recognize that the disclosed embodiments have relevance to a wide variety of applications and architectures in addition to those described below. In addition, the functionality of the subject matter of the present application can be implemented in software, hardware, or a combination of software and hardware. The hardware portion can be implemented using specialized logic; the software portion can be stored in a memory or recording medium and executed by a suitable instruction execution system such as a microprocessor.

More particularly, the embodiments herein include methods related to optimizing a color matrix sensor, such as a Bayer array sensor, and is appropriate for any digital imaging system wherein anti-aliasing filtration is lacking, such as smaller cameras and the like.

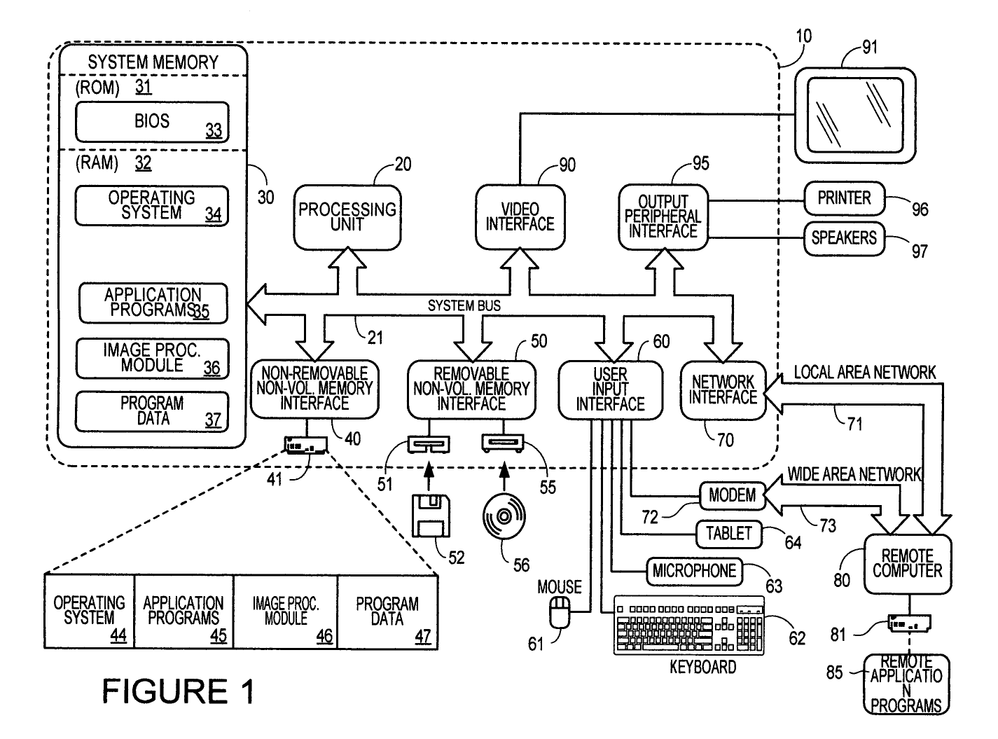

With reference to FIG. 1, an exemplary computing system for implementing the embodiments and includes a general purpose computing device in the form of a computer 10. Components of the computer 10 may include, but are not limited to, a processing unit 20, a system memory 30, and a system bus 21 that couples various system components including the system memory to the processing unit 20. The system bus 21 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 10 typically includes a variety of computer readable media. Computer readable media can be any available media that can be accessed by the computer 10 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 10. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 30 includes computer storage media in the form of volatile and/or nonvolatile memory such as read only memory (ROM) 31 and random access memory (RAM) 32. A basic input/output system 33 (BIOS), containing the basic routines that help to transfer information between elements within computer 10, such as during start-up, is typically stored in ROM 31. RAM 32 typically contains data and/or program modules that are immediately accessible to and/or presently being operated on by processing unit 20. By way of example, and not limitation, FIG. 1 illustrates operating system 34, application programs 35, other program modules 36 and program data 37. FIG. 1 is shown with program modules 36 including an image processing module in accordance with an embodiment as described herein.

The computer 10 may also include other removable/non-removable, volatile/nonvolatile computer storage media. By way of example only, FIG. 1 illustrates a hard disk drive 41 that reads from or writes to non-removable, nonvolatile magnetic media, a magnetic disk drive 51 that reads from or writes to a removable, nonvolatile magnetic disk 52, and an optical disk drive 55 that reads from or writes to a removable, nonvolatile optical disk 56 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 41 is typically connected to the system bus 21 through a non-removable memory interface such as interface 40, and magnetic disk drive 51 and optical disk drive 55 are typically connected to the system bus 21 by a removable memory interface, such as interface 50. An interface for purposes of this disclosure can mean a location on a device for inserting a drive such as hard disk drive 41 in a secured fashion, or a in a more unsecured fashion, such as interface 50. In either case, an interface includes a location for electronically attaching additional parts to the computer 10.

The drives and their associated computer storage media, discussed above and illustrated in FIG. 1, provide storage of computer readable instructions, data structures, program modules and other data for the computer 10. In FIG. 1, for example, hard disk drive 41 is illustrated as storing operating system 44, application programs 45, other program modules, including image processing module 46 and program data 47. Program modules 46 is shown including an image processing module, which can be configured as either located in modules 36 or 46, or both locations, as one with skill in the art will appreciate. More specifically, image processing modules 36 and 46 could be in non-volatile memory in some embodiments wherein such an image processing module runs automatically in an environment, such as in a cellular phone. In other embodiments, image processing modules could be part of a personal system on a hand-held device such as a personal digital assistant (PDA) and exist only in RAM-type memory. Note that these components can either be the same as or different from operating system 34, application programs 35, other program modules, including queuing module 36, and program data 37. Operating system 44, application programs 45, other program modules, including image processing module 46, and program data 47 are given different numbers hereto illustrate that, at a minimum, they are different copies. A user may enter commands and information into the computer 10 through input devices such as a tablet, or electronic digitizer, 64, a microphone 63, a keyboard 62 and pointing device 61, commonly referred to as a mouse, trackball or touch pad. Other input devices (not shown) may include a joystick, game pad, satellite dish, scanner, or the like. These and other input devices are often connected to the processing unit 20 through a user input interface 60 that is coupled to the system bus, but may be connected by other interface and bus structures, such as a parallel port, game port or a universal serial bus (USB). A monitor 91 or other type of display device is also connected to the system bus 21 via an interface, such as a video interface 90. The monitor 91 may also be integrated with a touch-screen panel or the like. Note that the monitor and/or touch screen panel can be physically coupled to a housing in which the computing device 10 is incorporated, such as in a tablet-type personal computer. In addition, computers such as the computing device 10 may also include other peripheral output devices such as speakers 97 and printer 96, which may be connected through an output peripheral interface 95 or the like.

The computer 10 may operate in a networked environment using logical connections to one or more remote computers, which could be other cell phones with a processor or other computers, such as a remote computer 80. The remote computer 80 may be a personal computer, a server, a router, a network PC, PDA, cell phone, a peer device or other common network node, and typically includes many or all of the elements described above relative to the computer 10, although only a memory storage device 81 has been illustrated in FIG. 1. The logical connections depicted in FIG. 1 include a local area network (LAN) 71 and a wide area network (WAN) 73, but may also include other networks. Such networking environments are commonplace in offices, enterprise-wide computer networks, intranets and the Internet. For example, in the subject matter of the present application, the computer system 10 may comprise the source machine from which data is being migrated, and the remote computer 80 may comprise the destination machine. Note however that source and destination machines need not be connected by a network or any other means, but instead, data may be migrated via any media capable of being written by the source platform and read by the destination platform or platforms.

When used in a LAN or WLAN networking environment, the computer 10 is connected to the LAN through a network interface or adapter 70. When used in a WAN networking environment, the computer 10 typically includes a modem 72 or other means for establishing communications over the WAN 73, such as the Internet. The modem 72, which may be internal or external, may be connected to the system bus 21 via the user input interface 60 or other appropriate mechanism. In a networked environment, program modules depicted relative to the computer 10, or portions thereof, may be stored in the remote memory storage device. By way of example, and not limitation, FIG. 1 illustrates remote application programs 85 as residing on memory device 81. It will be appreciated that the network connections shown are exemplary and other means of establishing a communications link between the computers may be used.

In the description that follows, the subject matter of the application will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer which reconfigures or otherwise alters the operation of the computer in a manner well understood by those skilled in the art. The data structures where data is maintained are physical locations of the memory that have particular properties defined by the format of the data. However, although the subject matter of the application is being described in the foregoing context, it is not meant to be limiting as those of skill in the art will appreciate that some of the acts and operation described hereinafter can also be implemented in hardware.

FIG. 1 illustrates program modules 36 and 46 can be configured to include a computer program for reducing, noise and chroma aliasing in images created using a color matrix sensor.

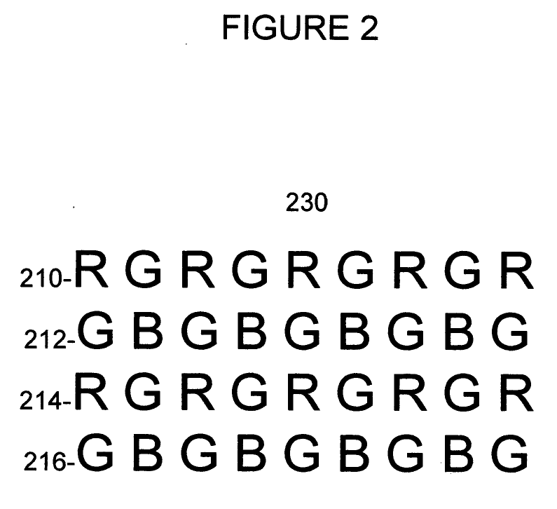

Referring now to FIG. 2, a matrix sensor is provided appropriate for imaging with a color-matrix sensor, such as a Bayer array sensor. As shown, there are 25% of pixels are red, 25% are blue, and 50% of the pixel sensors are green. In a matrix sensor, such as a Bayer-arrayed sensor, color is encoded according to a pattern of colored filters.

The array shows a simplistic version of the pixel arrangement in a Bayer array 230 with rows 210, 212, 214, and 216. As shown, the array 230 includes more green pixels (G) than red (R) or blue (B) pixels. The arrangement-produces a signal that can be captured by a digital camera in the form of R, G, and B signals. For JPG images and the like the signals received are combined into NTSC or PAL compatible signals that separate the luminance from the chrominance signals. One method of organizing the signals is to separate the signals into Y, I and Q signals. NTSC YIQ is given by the following formulas: Y=0.30R+0.59G+0.14B; I=0.74(R−Y)−0.27(B−Y); and Q=0.48(R−Y)+0.41 (B−Y).

Another channel, referred to herein as a “phantom” channel has been defined in pending patent application Ser. No. 11/203,564, incorporated herein for all purposes, entitled “SYSTEM AND METHOD FOR REDUCTION OF CHROMA ALIASING AND NOISE IN A COLOR-MATRIXED SENSOR” to Albert D. Edgar, filed Aug. 12, 2005. More particularly, a “phantom” channel can be defined as a G-G channel formed by subtracting the green pixels from the rows of green and red from the green pixels from the rows of green and blue. In one embodiment, the spatial phases are altered to generate standard color channels, such as a YIQ color definition or the like. For example, an I channel can be defined as the red spatial phase data minus the blue spatial phase data; a Q channel can be defined as the green minus magenta spatial phase data and/or the magenta minus green spatial phase data. More specifically, the Q channel can be defined as red-row green spatial phase data plus the blue-row green spatial phase data, then dividing the result by the red spatial phase data and the blue spatial phase data. The result of the division can then be normalized. A Y channel can be defined as a normalized sum of all the color spatial phase data.

The “Phantom” Channel

Color noise and aliasing can be found via a “phantom” channel found by subtracting a red-row green spatial phase from a blue-row green spatial phase.

The “phantom” channel can be used to remove aliasing and noise prior to constructing a standard color channel definition. Specifically, a “phantom” channel containing the noise and aliasing and an I channel contain data at same frequencies that are separated by spatial phases.

As is known, the I channel is most subject to aliasing and can benefit from embodiments disclosed herein due to aliasing caused by a pattern projected by the lens on the sampling grid. If a same sampling grid offset in position is subjected to a same type of interference, the result is displaced in spatial phase and not in frequency. Thus, any noise in the I channel is independent and can be identified using the embodiments disclosed herein.

The “phantom” channel can be examined by determining an absolute value, applying a high pass filter or applying a pyramid structure to separate different aliasing/noise at different frequencies. In one embodiment, a high pass filter is applied to avoid determining that differences between color channels that relate to image data are aliasing or noise.

Further, the filtered “phantom” channel data can be used to separate aliasing data from noise data. For example, a defined I channel can be manipulated by applying a low pass filter, such as a median filter to isolate image data. Next, one or more high pass filters can be applied to the I channel to isolate image data subject to aliasing and/or noise. The separated I channel data can then be manipulated to remove noise and aliasing by using the “phantom” channel. Thus, for example, a “phantom” channel isolated to identify high-pass noise and/or aliasing can be subtracted from the high pass I channel data. The high pass data can be used to identify the energy content in a given color channel. More particularly, the energy content can be defined by taking the absolute value of a given channel and applying a smoothing filter.

Once the energy content of the “phantom” channel and the I channel are isolated, comparisons can made to identify aliasing. For example, if luminance similarities are noted, an assumption can be made that the data represents signal and not aliasing. If, on the other hand, lighter areas appear in the I channel and not in a “phantom” channel, the difference can be assumed to be attributable to aliasing.

Aliasing can be located by dividing data identified as representing the energy in the I channel by the data identified as representing the energy in the “phantom” channel.

YIQ and Phantom Channel Image Enhancement

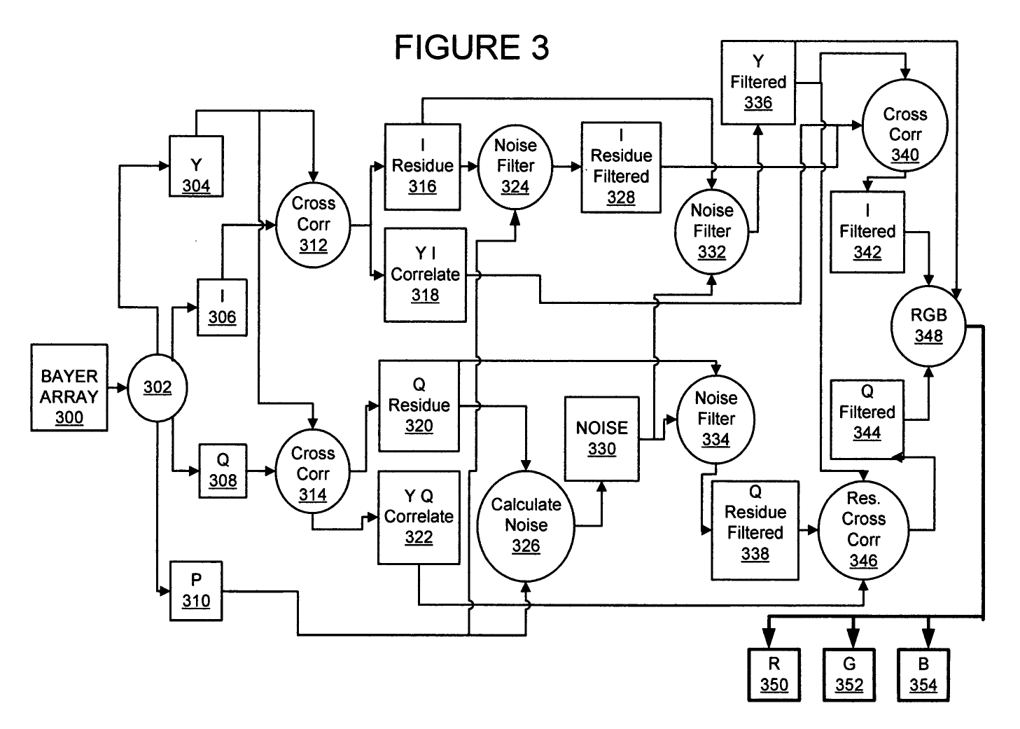

Referring now to FIG. 3, a schematic block diagram illustrates how the Y, I, Q and Phantom channels can be manipulated to enhance images created via a Bayer array. The images can be organized into a JPG image or the like, and produce red, green and blue signals. The red green and blue signals, after manipulation and according to an embodiment can be of equal resolution through a de-Bayerization process depicted.

According to an embodiment, the schematic block diagram of FIG. 3 can be applied to an image, or applied to a portion of an image. In one embodiment, the methods described with respect to FIG. 3 are performed on regions of an image, for example, 8×8 blocks or the like. In one embodiment, the method is performed on a composite image made up of two or more regions that can be operated on sequentially or simultaneously.

As shown a Bayer array 300 provides signals to element 302 which functions to separate the signals into Y, I, Q and “phantom” channels, designated as Y 304, I 306, Q 308 and P 310. Element 302 can also be configured to provide a high pass filter to remove baseband interference from the image.

Block 312 receives the Y and I channels and performs a cross correlation function. The cross correlation function can be performed by performing a double integral with respect to each dimension of an image. A constant “K”, referred to herein as a luminance value multiplier can be determined by either performing a cross correlation with Y and I and dividing by the auto correlation of the Y channel. Alternatively, the luminance value multiplier can be found by determining the power of the Y channel, subtracting the power of the I channel and then dividing the difference by the power of the Y channel. ∫∫Y(x,y)I(x,y)dxdy/∫∫Y²(x,y)dxdy=K_{I}=(∫∫Y²(x,y)dxdy−∫∫I²(x,y)dxdy)/∫∫Y²(x,y)dxdy The cross correlation function produces a residue, which can be defined as the equation equal to I(x,y)−KY(x,y), wherein K is the luminance value multiplier. The same cross correlation and determination of the constant K, luminance value multiplier, can be determined to determine the Q channel constant K_{Q}. Referring back to FIG. 3, the I residue is found and provided to I residue 316, representing the noise present in the I channel, and produces a Y, I correlate channel 318.

Likewise block 314 receives the Y and Q channels and performs a cross correlation function. The cross correlation function produces a Q residue 320 and a YQ correlate 322.

The output of the I residue 316 is shown provided to noise filter 324, which can also receive phantom channel 310 to provide a better noise filtering for the I channel. The filtered I residue data is shown as output 328. Similarly, the Q residue and the phantom channel 310 can be provided to calculate noise in block 326 and provide the noise in the phantom and Q channels in block 330. Noise filter 334 receives the noise from block 330 and from the Q residue 320. Noise 330 and I residue 316 are also provided to another noise filter 332, which filters the noise from the I and Q residues. The result of the filtered noise from block 332 is a filtered Y channel 336. The result of the filtered noise from block 334 is a filtered Q residue 338.

The output of the Y filtered channel 336 is provided to cross correlation block 340. Cross correlation block 340 also receives Y I correlate 318, the cross correlation result of the Y channel and the I channel, and the I residue filtered channel 328. The result of performing the cross correlation in block 340 is a filtered I channel 342.

The output of the filtered Q residue channel 336, the Y filtered channel 336 and the phantom channel 310 are provided to cross correlation block 346. The result is shown as a filtered Q channel 344.

The filtered I channel 342, the filtered Q channel 344 and the filtered Y channel 336 are then each provided to RGB 348. RGB 348 calculates the RBG channels and separates the red, green and blue signals into components red 350, green 352 and blue 354.

A pseudo code representation of the methods depicted in FIG. 3 can be shown as follows, with the phantom channel being depicted as an N array to represent the noise data, the “phantom” channel.

```
#define Width 1024 // image width
#define Height 768 // image height
#define Levels 5  // number of pyramid levels
// it is assumed that the Bayer array contains the raw
// output from a digital camera with a Bayer filter in
// front of the sensor
int Bayer[Height][Width];
// arrays for each of the color planes
int Red[Height][Width]; // Red
int Gred[Height][Width]; // red row Green
int Gblue[Height][Width]; // blue row Green
int Blue[Height][Width]; // Blue
// pointers to arrays at each level in hi-pass YIQN space
int *Yhi[Levels];
int *Ihi[Levels];
int *Qhi[Levels];
int *Nhi[Levels];
// pointers to arrays at each level in lo-pass YIQN space
int *Ylo[Levels];
int *Ilo[Levels];
int *Qlo[Levels];
int *Nlo[Levels];
// pointers to arrays at each level for envelope data
int *Ienv[Levels];
int *Qenv[Levels];
int *Nenv[Levels];
// pointers to arrays at each level for cross-correlation
// and auto-correlation
int *YI[Levels];
int *YQ[Levels];
int *YY[Levels];
int main( )
{
  // Separate the Bayer array into four sparse arrays:
  // Red, red row Green, blue row Green, and Blue
  BayerToRGGB( );
  // Demosaic the RGGB arrays to fill in the missing data
  LowPassFilter(Red);
  LowPassFilter(Gred);
  LowPassFilter(Gblue);
  LowPassFilter(Blue);
  // Allocate memory for the YIQN arrays
  // each level will be 1/2 the size of the one above it
  for(i = 0; i < Levels; i++)
    {
      Yhi[i] = new int [Height >> i][Width >> i];
      Ihi[i] = new int [Height >> i][Width >> i];
      Qhi[i] = new int [Height >> i][Width >> i];
      Nhi[i] = new int [Height >> i][Width >> i];
      Ylo[i] = new int [Height >> i][Width >> i];
      Ilo[i] = new int [Height >> i][Width >> i];
      Qlo[i] = new int [Height >> i][Width >> i];
      Nlo[i] = new int [Height >> i][Width >> i];
      Ienv[i] = new int [Height >> i][Width >> i];
      Qenv[i] = new int [Height >> i][Width >> i];
      Nenv[i] = new int [Height >> i][Width >> i];
      YI[i] = new int [Height >> i][Width >> i];
      YQ[i] = new int [Height >> i][Width >> i];
      YY[i] = new int [Height >> i][Width >> i];
    }
  // Convert the RGGB data into the top level YIQN data
  // Data is temporarily stored as lo-pass
  for(row = 0; row < Height; row++)
    {
      for(col = 0; col < Width; col++)
      {
        R = Red[row][col];
        Gr = Gred[row][col];
        Gb = Gblue[row][col];
        B = Blue[row][col];
        Ylo[0][row][col] = R + Gr + Gb + B;
        Ilo[0][row][col] = R − B;
        Qlo[0][row][col] = R − Gr − Gb + B;
        Nlo[0][row][col] = Gr − Gb;
      }
    }
  // Separate the YIQN data into hi-pass and low pass
  // arrays. Copy the low pass data to the next lower
  // level at 1/2 size and repeat the hi/lo separation.
  // Also calculate the correlate, residue, and envelope
  // data at this time.
  for(i = 0; i < Levels − 1; i++)
    {
      Yhi[i] = HighPassFilter(Ylo[i]);
      Ylo[i] = LowPassFilter(Ylo[i]);
      Ihi[i] = HighPassFilter(Ilo[i]);
      Ilo[i] = LowPassFilter(Ilo[i]);
      Qhi[i] = HighPassFilter(Qlo[i]);
      Qlo[i] = LowPassFilter(Qlo[i]);
      Nhi[i] = HighPassFilter(Nlo[i]);
      Nlo[i] = LowPassFilter(Nlo[i]);
      YI[i] = CrossCorrelate(Yhi[i], Ihi[i]);
      YQ[i] = CrossCorrelate(Yhi[i], Qhi[i]);
      YY[i] = AutoCorrelate(Yhi[i]);
      Ihi[i] −= YI[i]/YY[i];
      Qhi[i] −= YQ[i]/YY[i];
      Ienv[i] = LowPassFilter(AbsoluteValue(Ihi[i]));
      Qenv[i] = LowPassFilter(AbsoluteValue(Qhi[i]));
      Nenv[i] = LowPassFilter(AbsoluteValue(Nhi[i]));
      Ylo[i + 1] = Downsize(Ylo[i]);
      Ilo[i + 1] = Downsize(Ilo[i]);
      Qlo[i + 1] = Downsize(Qlo[i]);
      Nlo[i + 1] = Downsize(Nlo[i]);
    }
  // At each level but the lowest, filter the noise from
  // the Y, I, and Q data
  for(i = 0; i < Levels − 1; i++)
    {
      Ihi[i] = I_NoiseFilter(Ihi[i], Ienv[i], Nenv[i]);
      Yhi[i] = Y_NoiseFilter(Yhi[i], Qenv[i], Nenv[i]);
      Qhi[i] = Q_NoiseFilter(Qhi[i], Qenv[i], Nenv[i]);
    }
  // Starting at the lowest level add the data back up to
  // the top. The lower level data needs to double in
  size
    // to match the level above it
    for(i = Levels − 2; i >= 0; i−−)
      {
        Ylo[i] = Upsize(Ylo[i + 1]) + Yhi[i];
        Ilo[i] = Upsize(Ilo[i + 1]) + Ihi[i] +
  (YI[i]/YY[i]);
        Qlo[i] = Upsize(Qlo[i + 1]) + Qhi[i] +
  (YQ[i]/YY[i]);
      }
    // Convert the uppermost level YIQN data back to RGGB
    for(row = 0; row < Height; row++)
      {
        for(col = 0; col < Width; col++)
          {
            Y = Ylo[0][row][col];
            I = Ilo[0][row][col];
            Q = Qlo[0][row][col];
            N = Nlo[0][row][col];
            Red[row][col] = (Y + 2*I + Q) / 4;
            Blue[row][col] = (Y − 2*I + Q) / 4;
            Gred[row][col] = (Y − Q + 2*N) / 4;
            Gblue[row][col] = Gred − N;
        }
      }
    // The image is now corrected and can be output as
  desired
    SaveToFile( );
  }
```

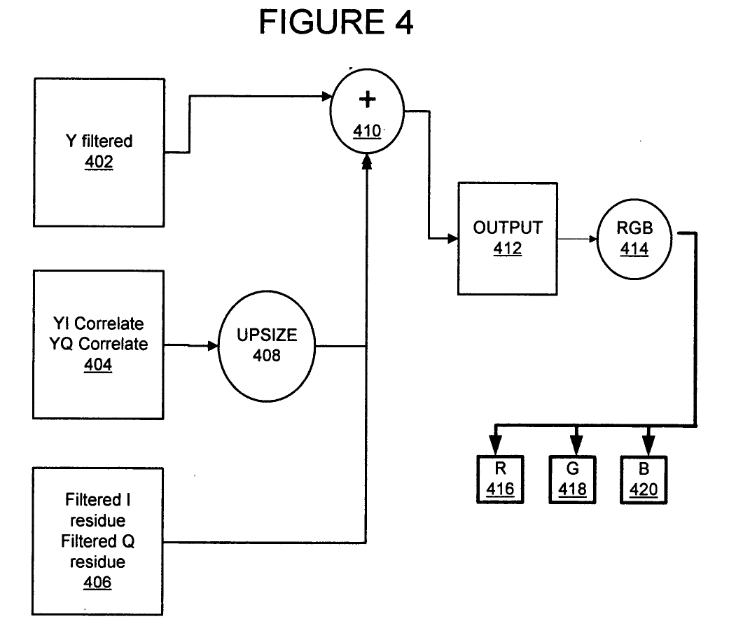

Referring now to FIG. 4, a schematic block diagram illustrates post processing of the image. Block 402 represents the Y filtered component, Block 404 represents the YQ correlate and the YI correlate components and block 406 represents the I and Q filtered residue components. Block 408 represents upsizing the YQ and YI correlate components. Each of the output of block 408, bock 406 and block 402 are added to produce an enhanced image, or region of a composite image.

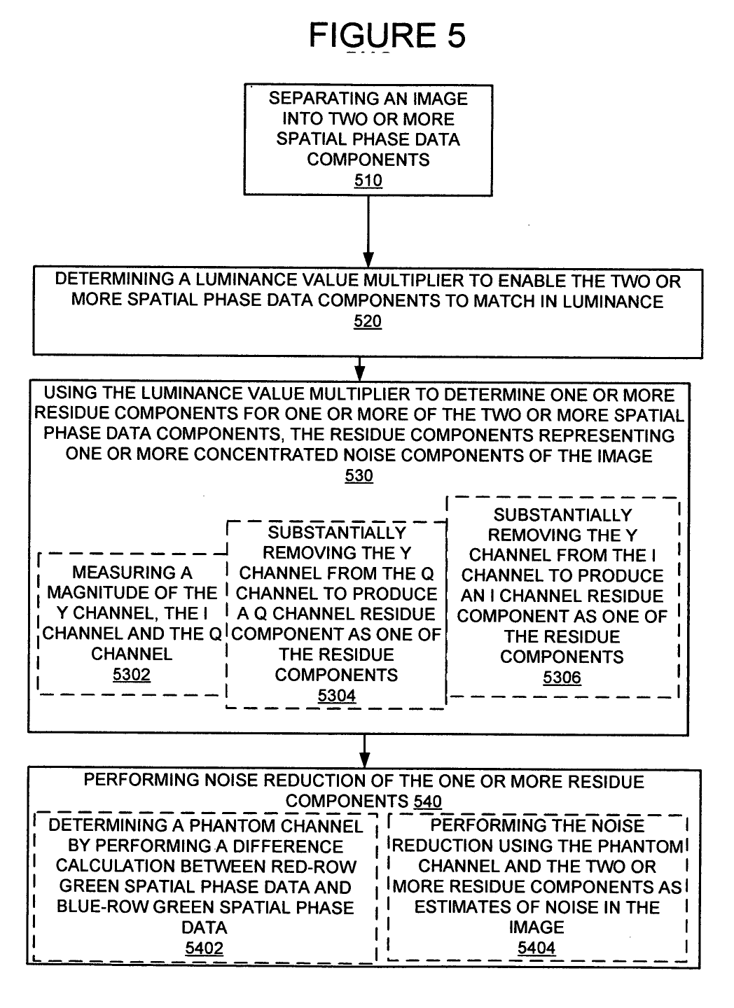

Referring now to FIG. 5, a flow diagram illustrates methods according to embodiments. Block 510 provides for separating the image into two or more spatial phase data components. Separating the image into two or more spatial phase components, in one embodiment, includes separating a digital representation of an image into red, green and blue spatial phase components of a Bayer sensor array, and can include separating by rows, such that green components are separated into those rows having blue sensors versus those rows having red sensors as described above with respect to creating a “phantom” channel. Separating the image into two or more spatial phase components, in another embodiment, can describe separating the digital representation of the image into any components that describe a spatial relationship on a Bayer sensor array to describe different components of the digital representation, such as Y, I, Q channels, Y, U, V channels and the like.

Block 520 provides for determining a luminance value multiplier to enable the two or more spatial phase data components to match in luminance. In one embodiment, the image is a region of a composite image including two or more regions, the determining a luminance value multiplier to enable the two or more spatial phase data components to match in luminance can be performed on the two or more regions of the composite image such as 8×8 pixel blocks or the like.

As described above, a luminance value multiplier, “K”, is determined by taking a cross correlation of a luminance value with a color value and dividing by a luminance value, such as an auto correlation of the luminance. The K value provides a representation of the amount of luminance in a color channel. Other methods of determining the luminance value multiplier include determining a Q channel luminance value multiplier by subtracting a power of the Y channel from a power of the Q channel and dividing a result by the power of the Y channel; and determining an I channel luminance value multiplier by subtracting the power of the Y channel from the power of the I channel and dividing the result by the power of the Y channel.

Block 530 provides for using the luminance value multiplier to determine one or more residue components for one or more of the two or more spatial phase data components, the residue components representing one or more concentrated noise components of the image. The residue can determined by calculating an I channel residue component by subtracting from the Y channel, the I channel multiplied by the I channel luminance value multiplier multiplied with the Y channel. A Q channel residue component can be calculated by subtracting from the Y channel the Q channel luminance value multiplier multiplied with the Y channel.

Depicted within block 530 are optional block 5302, 5304 and 5306. The optional blocks refer to Y, I and Q channels. More specifically, in an embodiment, the two or more spatial phase data components are an I channel including red spatial phase data minus blue spatial phase data, a Q channel including green spatial phase data minus magenta spatial phase data and/or magenta spatial phase data minus green spatial phase data, and a Y channel including a normalized sum of each of the Q and I channel color spatial phase data.

Block 5302 provides for measuring a magnitude of the Y channel, the I channel and the Q channel. Block 5304 provides for substantially removing the Y channel from the Q channel to produce a Q channel residue component as one of the residue components. Block 5306 provides for substantially removing the Y channel from the I channel to produce an I channel residue component as one of the residue components.

Block 540 provides for performing noise reduction of the one or more residue components. Performing noise reduction can include determining a phantom channel by performing a difference calculation between red-row green spatial phase data and blue-row green spatial phase data; and performing the noise reduction using the phantom channel and the two or more residue components as estimates of noise in the image.

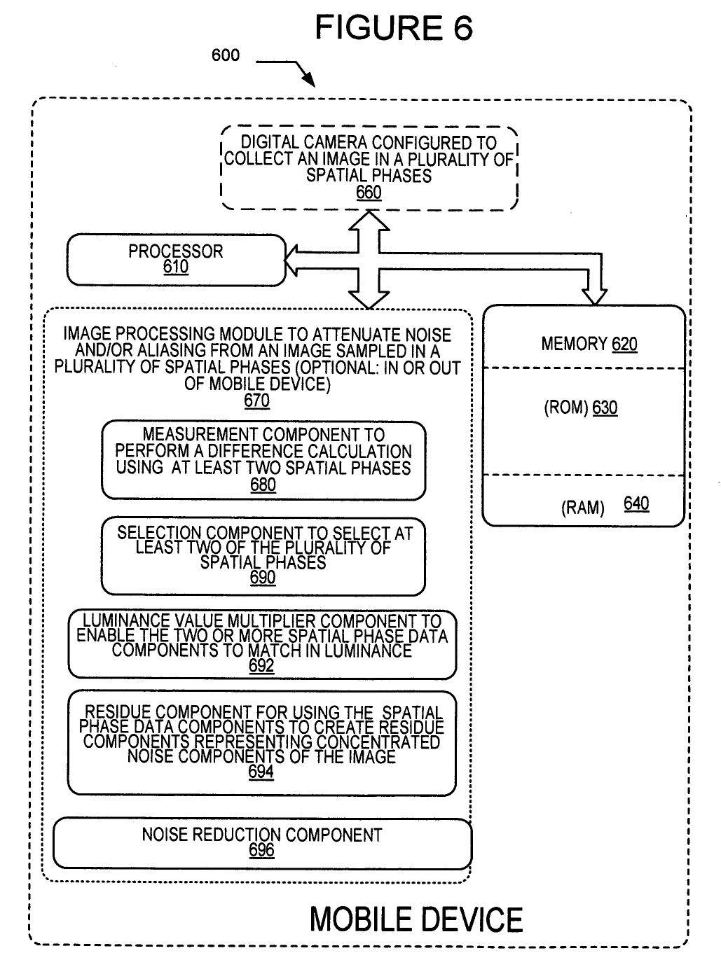

Referring now to FIG. 6, a block diagram illustrates a computer system 600 implementation that could be disposed in a mobile device. More particularly, FIG. 6 illustrates a processor 610, memory 620 coupled to the processor, including either ROM 630 or RAM 640. Computer system 600 also includes digital camera 660 configured to collect an image in a plurality of spatial phases, such as from a Bayer array. Coupled to processor 610 is shown image processing module 670 coupled to the memory, the image processing module configured to attenuate noise and/or aliasing from an image sampled in a plurality of spatial phases. Image processing module 670 includes a measurement component 680 to perform a difference calculation using at least two spatial phases, a selection component 690 to select at least two of the plurality of spatial phases, a luminance value multiplier component 692 to enable the two or more spatial phase data components to match in luminance, and a residue component 694 for using the one or more spatial phase data components to create one or more residue components representing concentrated noise components of the image.

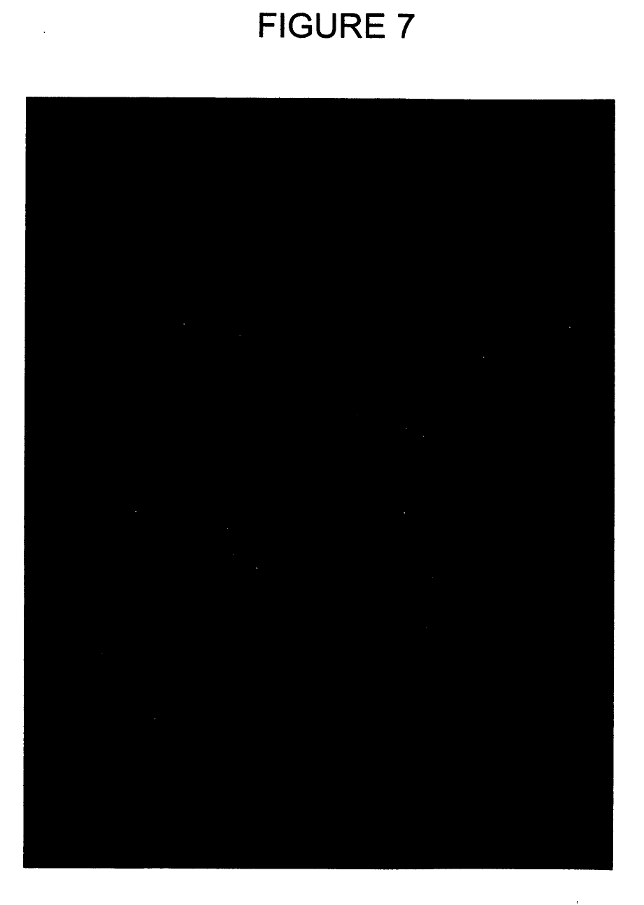

Referring now to FIGS. 7-18 are images describing embodiments herein. FIG. 7 represents an image collected by a raw Bayer array. Often the red and blue sensors have lower sensitivity than the green, partly because of the density of practical filters, and partly to handle a wider range of color temperatures without clipping the critical green channel. The result is that raw Bayer images are typically greenish. The green color is typically removed by raising, and, therefore, clipping red and blue. The raising of red and blue color corrects a specific illuminant. Because once clipped, any later attempt to change the illuminant color will further loose highlight detail that was in the original Bayer image. It is therefore desireable to do a deBayerization that does not require perfect knowledge of scene color balance before the deBayerization, thereby allowing scene color balance to be done after deBayerization has rendered the scene more clearly visible and easy to work with.

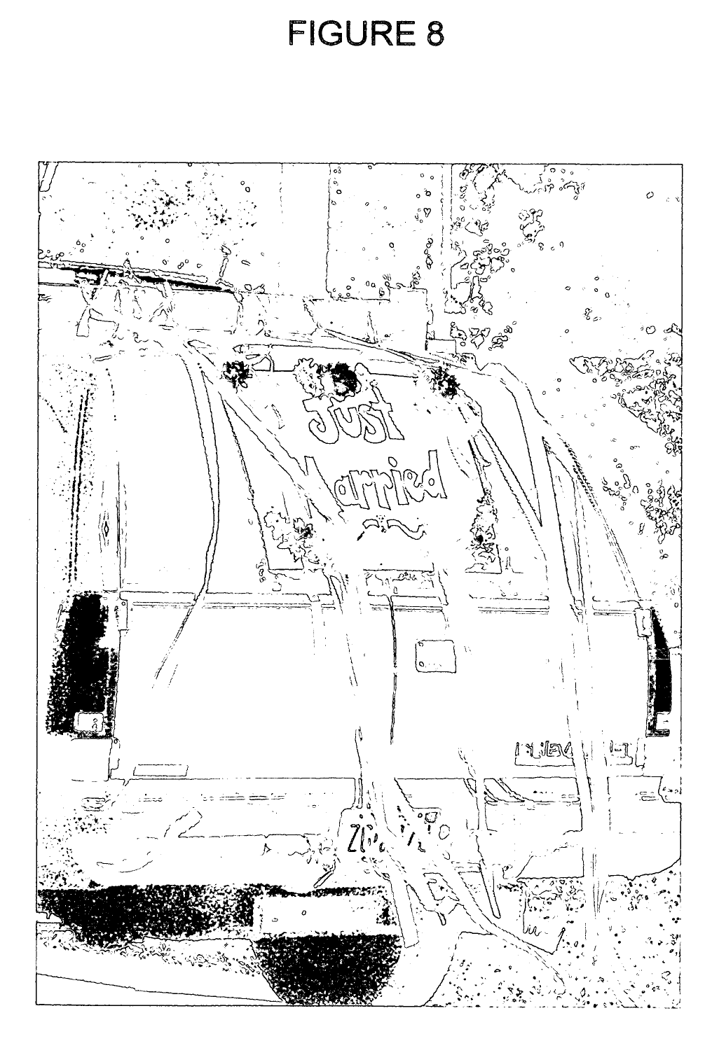

FIG. 8 illustrates a “Q channel” or the “Green-Magenta” color axis. The image is light and has some detail from the luminance channel because the green sensors are stronger than the red and blue. Note that the green colors can appear very light, and the red and blue colors can appear darker than a black. In the prior art, this image would now be noise processed, then reassembled to create the RGB image. In the prior art, imperfections in the noise processing would loose some of the detail in this image, along with the noise.

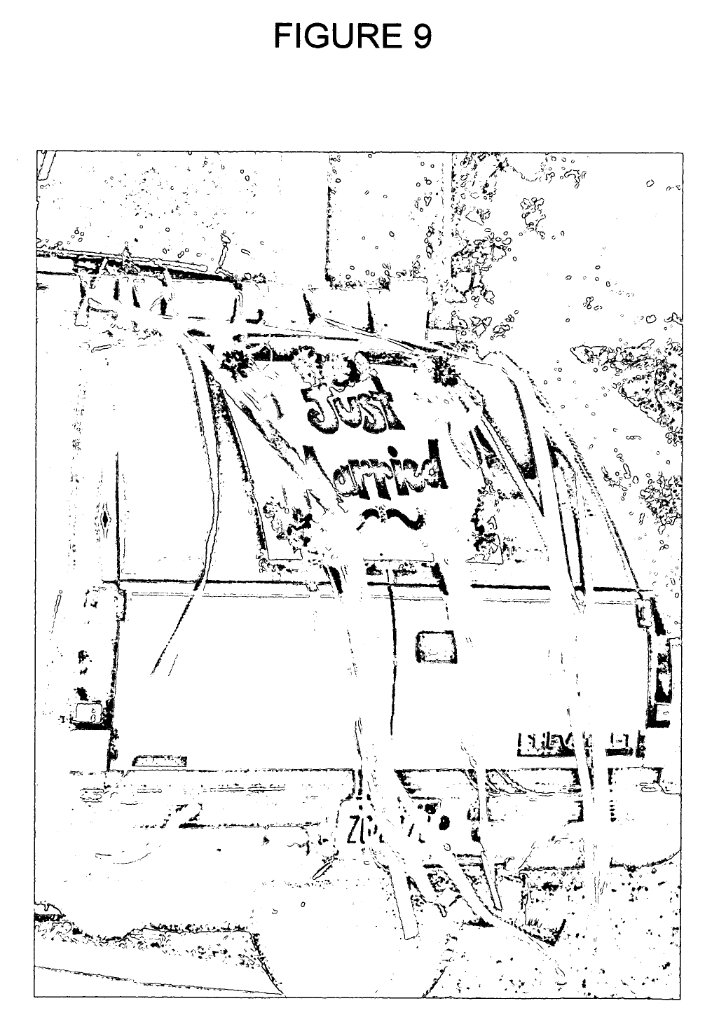

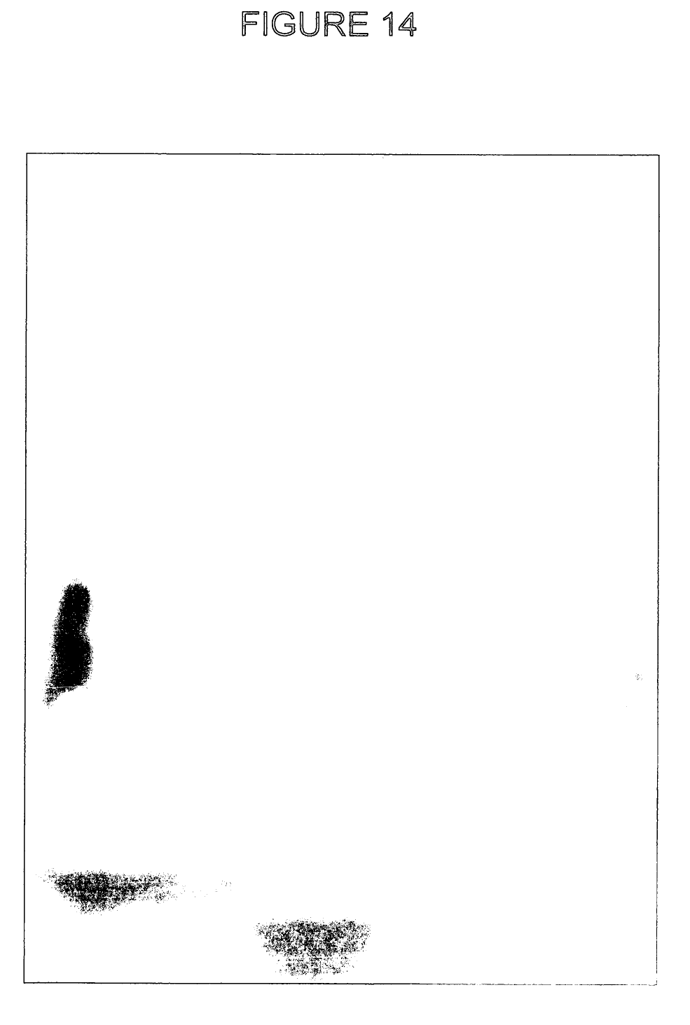

FIG. 9 illustrates the high spatial frequencies of the image in FIG. 8. The other spatial frequencies of the image, including the low frequencies of the image in FIG. 8, (see FIG. 14), according to an embodiment, can avoid further processing because the low frequency components are typically substantially noise-free.

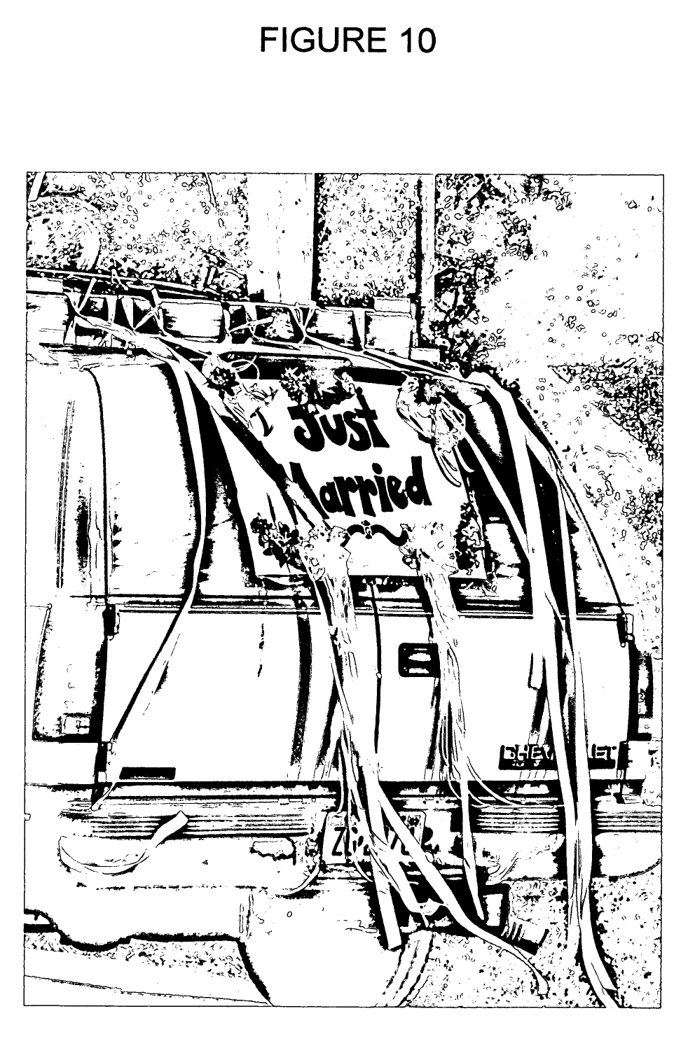

FIG. 10 illustrates the high spatial frequencies of the luminance (red+green1+green2+blue) channel. The luminance channel is much stronger than the color channels, and therefore appears with less noise.

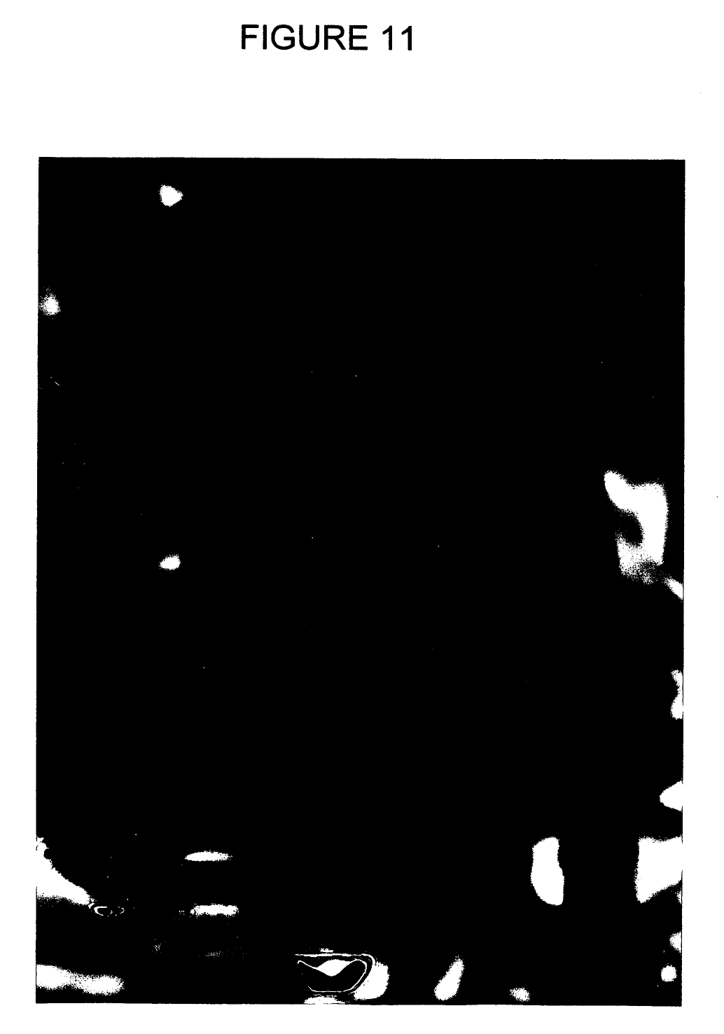

FIG. 11 illustrates a correlate map, showing, for each region, the value needed by which to multiply the image of FIG. 10 to provide a best fit for the image of FIG. 9. Note particularly that although generally positive because of the greenish tint of the original image, it is not uniform, and in particular swings wildly in regions of bright color. According to one embodiment, the correlate map can be used as a code for how to add the predictable relationship between luminance and the Q channel back into a filtered Q image.

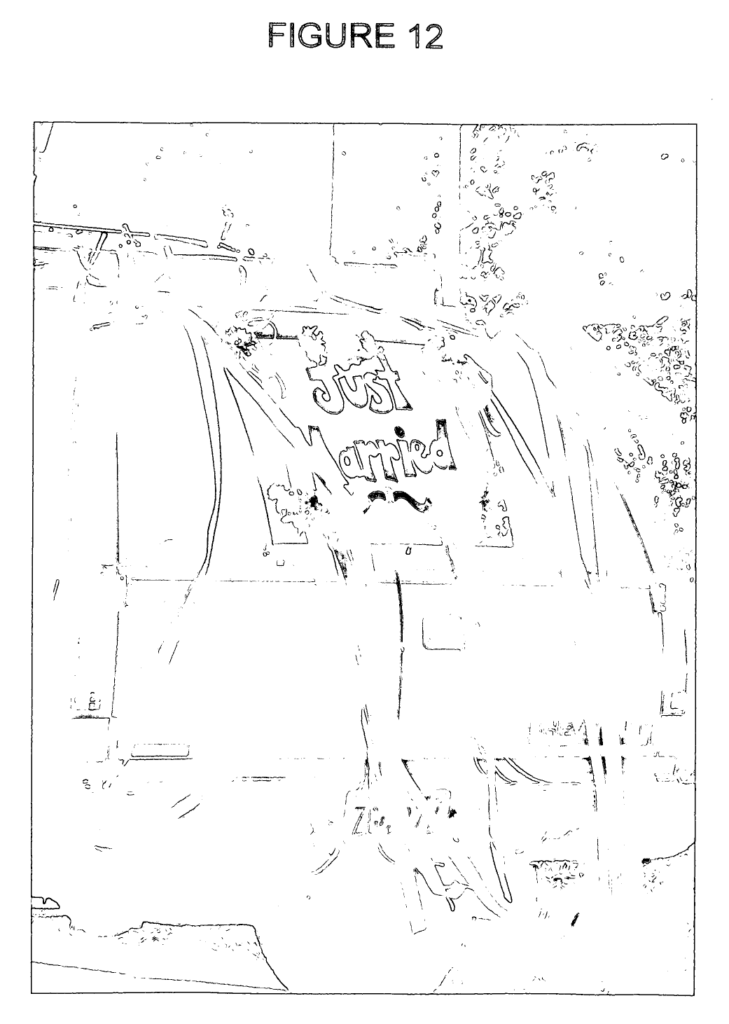

FIG. 12 illustrates a result of employing embodiments disclosed herein. More particularly, FIG. 12 illustrates a resulting best fit to the image of FIG. 9 using images of FIG. 10 multiplied by image of FIG. 11. FIG. 12 illustrates much of the detail of image of FIG. 8, but almost none of the noise. To gain further enhancement, noise suppression can be applied to the image.

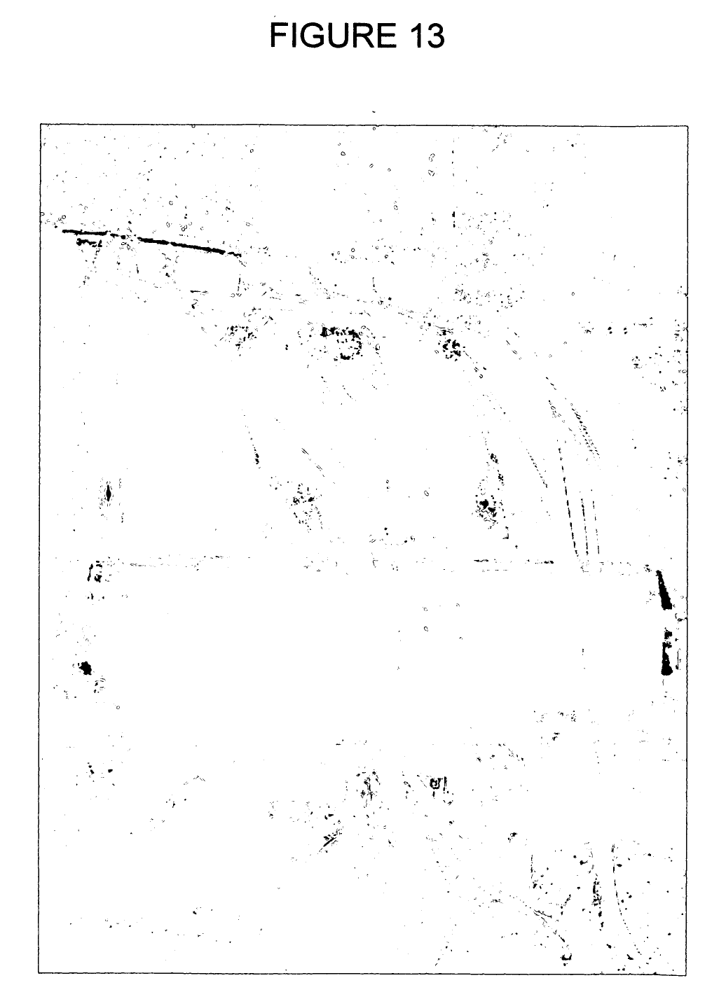

FIG. 13 illustrates a “residue” resulting from subtracting the image of FIG. 12 from the image of FIG. 9. There are some desired details in the image of FIG. 13, particularly across the brightly colored areas, however because there is much less desired detail in image 13 than in image 9, any missteps in noise suppression will have less detail to damage.

Referring now to FIG. 14-18, for comparison purposes, noise suppression is performed by erasing all the detail using a low pass filter. By applying a low pass filter, and comparing the results, one of skill in the art will appreciate how well the correlate extraction has insulated the image from “bad” noise suppression that removes detail from an image.

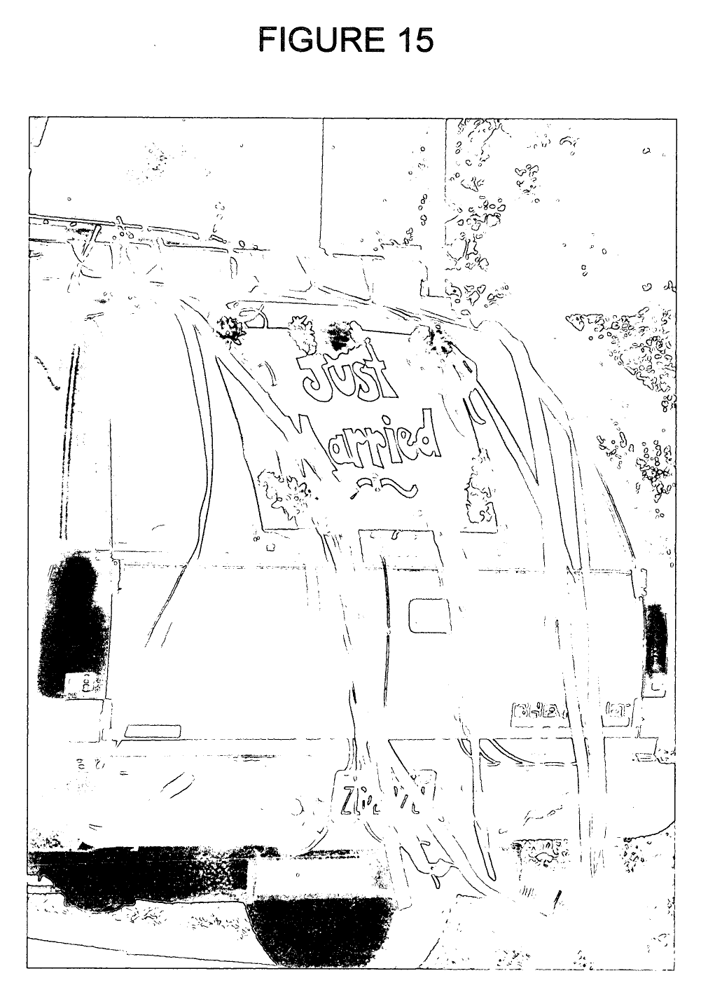

FIG. 14 illustrates a low-pass version of the image of FIG. 8. As shown, FIG. 8 appears with all the detail shown in FIG. 9 erased by “bad” noise suppression. FIG. 15 illustrates the “bad” noise suppression of the image of FIG. 14 with the preserved detail set aside in the image of FIG. 12 added back in. Note that the structure does not match the desired structure shown in the image of FIG. 8 exactly, but it is closer to the image of FIG. 8 than the image of FIG. 14, and the noise is virtually gone.

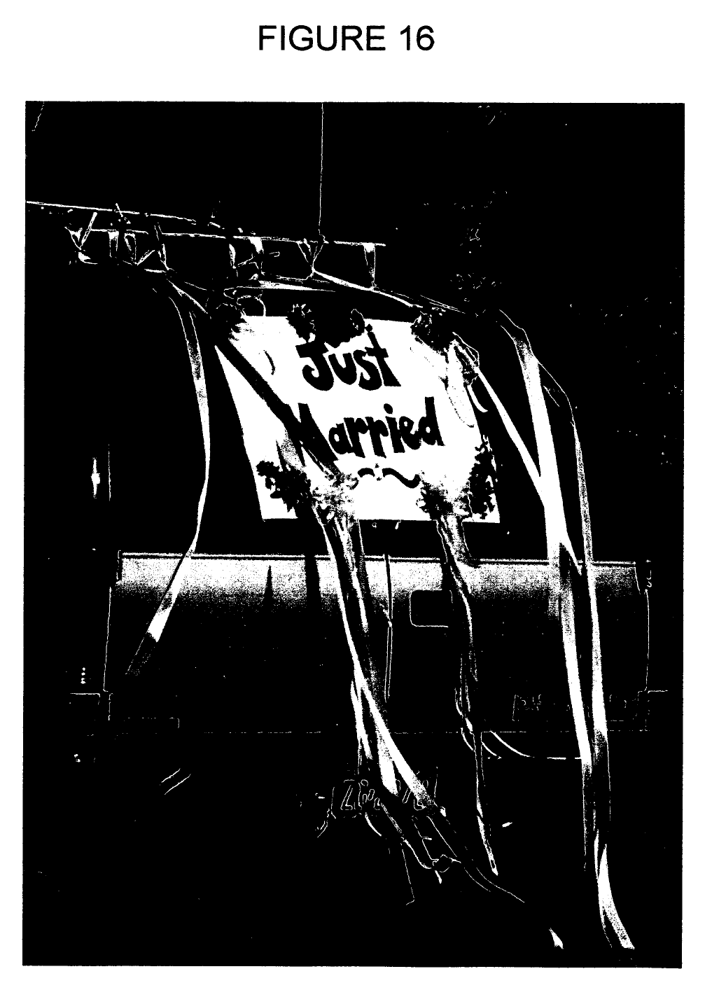

FIG. 16 illustrates a deBayerized image reconstructed using image of FIG. 14 as the Q channel. Because it is green and weak in color, it is hard to see whether there are any defects.

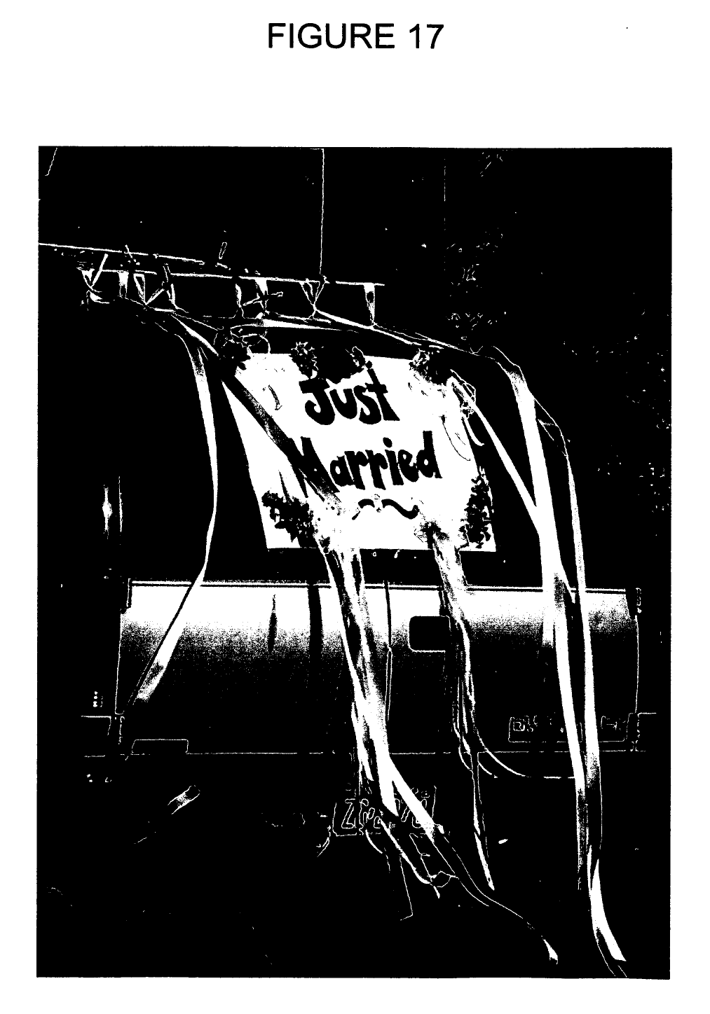

FIG. 17 illustrates an equivalent to the image of FIG. 16 except that the image according to an embodiment shown in FIG. 15 replaces the image of FIG. 14 as the Q channel.

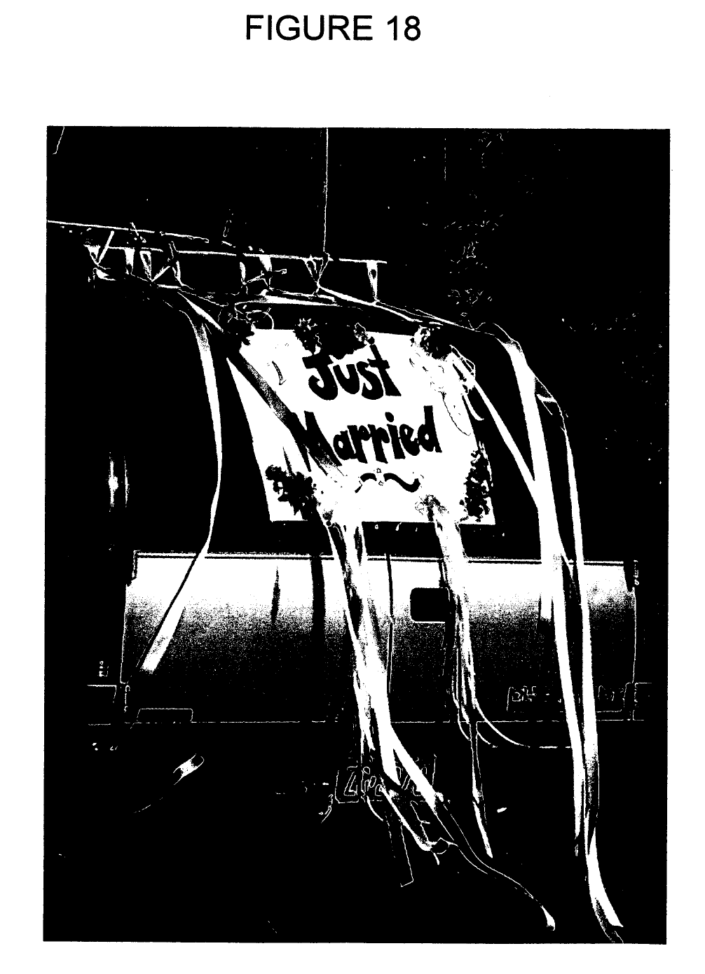

FIG. 18 illustrates the image of FIG. 16 after post-deBayerization illuminant correction and necessary color boosts, as one of skill in the art with the benefit of the present disclosure will appreciate.

The image shown in FIG. 18 is marred by green and magenta hazing around details, while the image of FIG. 17 shows stable grays.

It will be apparent to those skilled in the art that many other alternate embodiments of the present invention are possible without departing from its broader spirit and scope. Moreover, in other embodiments the methods and systems presented can be applied to other types of signal than signals associated with camera images, comprising, for example, medical signals and video signals.

While the subject matter of the application has been shown and described with reference to particular embodiments thereof, it will be understood by those skilled in the art that the foregoing and other changes in form and detail may be made therein without departing from the spirit and scope of the subject matter of the application, including but not limited to additional, less or modified elements and/or additional, less or modified steps performed in the same or a different order.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The herein described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

I claim:

1. A method for enhancing an image, the method comprising:
separating the image into two or more spatial phase data components;
determining a luminance value multiplier to enable the two or more spatial phase data components to match in luminance;
using the luminance value multiplier to determine one or more residue components for one or more of the two or more spatial phase data components, the residue components representing one or more concentrated noise components of the image; and
performing noise reduction of the one or more residue components.

2. The method of claim 1 wherein the image is a region of a composite image including two or more regions, the determining a luminance value multiplier to enable the two or more spatial phase data components to match in luminance being performed on the two or more regions of the composite image.

3. The method of claim 2 wherein the two or more regions of a composite image are 8×8 pixel blocks of the image.

4. The method of claim 1 wherein the two or more spatial phase data components are an I channel including red spatial phase data minus blue spatial phase data, a Q channel including green spatial phase data minus magenta spatial phase data and/or magenta spatial phase data minus green spatial phase data, and a Y channel including a normalized sum of each of the Q and I channel color spatial phase data.

5. The method of claim 4 wherein the using the luminance value multiplier to determine one or more residue components for one or more of the two or more spatial phase data components, the residue components representing one or more concentrated noise components of the image includes:
measuring a magnitude of the Y channel, the I channel and the Q channel;
substantially removing the Y channel from the Q channel to produce a Q channel residue component as one of the residue components; and
substantially removing the Y channel from the I channel to produce an I channel residue component as one of the residue components.

6. The method of claim 4 wherein the determining a luminance value multiplier to enable the two or more spatial phase data components to match in luminance includes:
calculating an I channel residue component by subtracting from the Y channel, the I channel multiplied by the I channel luminance value multiplier multiplied with the Y channel; and
calculating a Q channel residue component by subtracting from the Y channel the Q channel luminance value multiplier multiplied with the Y channel.

7. The method of claim 4 wherein the determining a luminance value multiplier to enable the two or more spatial phase data components to match in luminance includes:
using the residue components as a predictor of noise present in the Y channel.

8. The method of claim 4 wherein the determining a luminance value multiplier to enable the two or more spatial phase data components to match in luminance method includes:
performing a cross correlation of the Y channel with each of the Q channel and the I channel; and
dividing each cross correlation by an autocorrelation of the Y channel to obtain the luminance value multiplier.

9. The method of claim 4 wherein the determining a luminance value multiplier to enable the two or more spatial phase data components to match in luminance includes:
determining Q channel luminance value multiplier by subtracting a power of the Y channel from a power of the Q channel and dividing a result by the power of the Y channel; and
determining an I channel luminance value multiplier by subtracting the power of the Y channel from the power of the I channel and dividing the result by the power of the Y channel.

10. The method of claim 1 wherein the performing noise reduction of the one or more residue components includes:
determining a phantom channel by performing a difference calculation between red-row green spatial phase data and blue-row green spatial phase data; and
performing the noise reduction using the phantom channel and the two or more residue components as estimates of noise in the image.

11. The method of claim 1 further comprising:
performing a high pass filtering to remove a base band bias from the image prior to determining a luminance value multiplier to enable the two or more spatial phase data components to match in luminance.

12. The method of claim 1 further comprising:
altering the Y channel using the one or more residue components following the noise reduction.

13. The method of claim 12 further comprising:
combining the altered Y channel, one or more residue components following the noise reduction and one or more cross correlation components to provide a deBayerized RGB image.

14. The method of claim 12 further comprising:
altering the Y channel using the one or more residue components following the noise reduction.

15. A computer program product comprising:
a signal bearing medium bearing;
one or more instructions for separating the image into two or more spatial phase data components;
one or more instructions for determining a luminance value multiplier to enable the two or more spatial phase data components to match in luminance;
one or more instructions for using the luminance value multiplier to determine one or more residue components for one or more of the two or more spatial phase data components, the residue components representing one or more concentrated noise components of the image; and
one or more instructions for performing noise reduction of the one or more residue components.

16. The computer program product of claim 15 wherein the signal bearing medium comprises:
a recordable medium.

17. The computer program product of claim 15 wherein the signal bearing medium comprises:
a transmission medium.

18. The computer program product of claim 15 wherein the image is a region of a composite image including two or more regions, the determining a luminance value multiplier to enable the two or more spatial phase data components to match in luminance being performed on the two or more regions of the composite image.

19. The computer program product of claim 18 wherein the two or more regions of a composite image are 8×8 pixel blocks of the image.

20. The computer program product of claim 15 wherein the two or more spatial phase data components are an I channel including red spatial phase data minus blue spatial phase data, a Q channel including green spatial phase data minus magenta spatial phase data and/or magenta spatial phase data minus green spatial phase data, and a Y channel including a normalized sum of each of the Q and I channel color spatial phase data.

21. The computer program product of claim 20 wherein the one or more instructions for using the luminance value multiplier to determine one or more residue components for one or more of the two or more spatial phase data components, the residue components representing one or more concentrated noise components of the image includes:
one or more instructions for measuring a magnitude of the Y channel, the I channel and the Q channel;
one or more instructions for substantially removing the Y channel from the Q channel to produce a Q channel residue component as one of the residue components; and
one or more instructions for substantially removing the Y channel from the I channel to produce an I channel residue component as one of the residue components.

22. The computer program product of claim 20 wherein the one or more instructions for determining a luminance value multiplier to enable the two or more spatial phase data components to match in luminance includes:
one or more instructions for calculating an I channel residue component by subtracting from the Y channel, the I channel multiplied by the I channel luminance value multiplier multiplied with the Y channel; and
one or more instructions for calculating a Q channel residue component by subtracting from the Y channel the Q channel luminance value multiplier multiplied with the Y channel.

23. The computer program product of claim 20 wherein the one or more instructions for the determining a luminance value multiplier to enable the two or more spatial phase data components to match in luminance includes:
one or more instructions for using the residue components as a predictor of noise present in the Y channel.

24. The computer program product of claim 20 wherein the one or more instructions for the determining a luminance value multiplier to enable the two or more spatial phase data components to match in luminance includes:
one or more instructions for performing a cross correlation of the Y channel with each of the Q channel and the I channel; and
one or more instructions for dividing each cross correlation by an autocorrelation of the Y channel to obtain the luminance value multiplier.

25. The computer program product of claim 20 wherein the one or more instructions for the determining a luminance value multiplier to enable the two or more spatial phase data components to match in luminance includes:
one or more instructions for determining Q channel luminance value multiplier by subtracting a power of the Y channel from a power of the Q channel and dividing a result by the power of the Y channel; and
one or more instructions for determining an I channel luminance value multiplier by subtracting the power of the Y channel from the power of the I channel and dividing the result by the power of the Y channel.

26. The computer program product of claim 15 wherein the performing noise reduction of the one or more residue components includes:
one or more instructions for determining a phantom channel by performing a difference calculation between red-row green spatial phase data and blue-row green spatial phase data; and
one or more instructions for performing the noise reduction using the phantom channel and the two or more residue components as estimates of noise in the image.

27. The computer program product of claim 15 further comprising:
one or more instructions for performing a high pass filtering to remove a base band bias from the image prior to determining a luminance value multiplier to enable the two or more spatial phase data components to match in luminance.

28. The computer program product of claim 15 further comprising:
one or more instructions for altering the Y channel using the one or more residue components following the noise reduction.

29. The computer program product of claim 28 further comprising:
one or more instructions for combining the altered Y channel, one or more residue components following the noise reduction and one or more cross correlation components to provide a deBayerized RGB image.

30. The computer program product of claim 28 further comprising:
one or more instructions for altering the Y channel using the one or more residue components following the noise reduction.

31. A computer system comprising:
a processor;
a memory coupled to the processor;
an image processing module coupled to the memory, the image processing module configured to attenuate noise and/or aliasing from an image sampled in a plurality of spatial phases, the image processing module including:
a measurement component to perform a difference calculation using at least two spatial phases; and
a selection component to select at least two of the plurality of spatial phases;
a luminance value multiplier component to enable the two or more spatial phase data components to match in luminance;
a residue component for using the one or more spatial phase data components to create one or more residue components representing concentrated noise components of the image.

32. The computer system of claim 31 wherein the image processing module is disposed in a mobile device.

33. The computer system of claim 31 wherein the image processing module is configured to receive image data via one or more of a wireless local area network (WLAN), a cellular and/or mobile system, a global positioning system (GPS), a radio frequency system, an infrared system, an IEEE 802.11 system, and a wireless Bluetooth system.

34. The computer system of claim 31 wherein the image processing module is configured to receive image data via one or more of a wireless local area network (WLAN), a cellular and/or mobile system, a global positioning system (GPS), a radio frequency system, an infrared system, an IEEE 802.11 system, and a wireless Bluetooth system.
